(19) United States
(12) Patent Application Publication
(10) Pub. No.: US 2008/0304701 A1
(43) Pub. Date: Dec. 11, 2008

(54) Image processing apparatus

(75) Inventors: Yoshiyuki Nakai, Nara (JP); Akihiko Taniguchi, Nara (JP); Yohichi Shimazawa, Nara (JP); Koichi Sumida, Nara (JP)

Correspondence Address: EDWARDS ANGELL PALMER & DODGE LLP, P.O. BOX 55874, BOSTON, MA, 02205, US

(73) Assignee: Sharp Kabushiki Kaisha, Osaka (JP)

(21) Appl. No.: 12/156,139

(22) Filed: May 30, 2008

(30) Foreign Application Priority Data
Jun. 7, 2007 (JP) 2007-151695

(51) Int. Cl. G06K 9/80

(52) U.S. Cl. 382/100

(57) ABSTRACT

An image processing apparatus in which a specific image including regulation information and a specific image including trace information are attached so that the specific images are different from each other is provided. An image processing apparatus 1 of the present invention is provided with an image reading section 210, an image forming section 220, an image storage section 400, an operation section 240 and a control section 300, in a cabinet 2. The control section 300 is provided with a first specific image adding section 311, a second specific image adding section 308, a determination section 312, an altering section 313 and a CPU 301. The determination section 312 compares a first specific image A and a second specific image B which have been generated. When it has been determined that a part of the second specific image B is the first specific image A, the altering section 313 alters the second specific image B. The second specific image adding section 308 adds the altered second specific image B.

### BACKGROUND OF THE INVENTION

1. Field of the Invention

The present invention relates to an image processing apparatus which adds a specific image to image data and outputs it.

2. Description of the Related Art

A document which has been printed with image data and outputted by an image processing apparatus may include confidential information. If this document is copied in an unauthorized manner, a recorded material including the confidential information is outputted. If the recorded material is brought out, the confidential information is leaked to the outside.

Consequently, in order to prevent the leakage of the confidential information to the outside, for example, as shown in Japanese Patent Laid-Open No. 2000-175027, there is a method of adding a specific image including trace information for tracing a source of the recorded material so that a person who has performed unauthorized use can be identified. Alternatively, there is a method of adding a specific image including regulation information for, when the document is read, enabling each image processing apparatus to recognize that copy inhibition is applied to the above described document.

Incidentally, since the regulation information is required to be recognized in all image processing apparatuses, the specific image including the regulation information is added with a prescribed specific pattern. However, since information on the image processing apparatus is formed as a pattern in the specific image including the trace information, the specific image including the trace information is added with the pattern different in each image processing apparatus. Thus, a part of a specific pattern of the specific image including the trace information may become the same as the specific pattern of the specific image including the regulation information. In this case, for example, when a document added with the specific image including the trace information having the same specific pattern as the specific pattern of the specific image including the regulation information has been read, there is a problem in which the image processing apparatus misrecognizes that there is the regulation information from the read specific image. In other words, even if the specific image including the regulation information has not been added to the document, there is a problem in which the image processing apparatus recognizes that the regulation information has been added and regulates a processing such as the copy inhibition based on the regulation information.

Consequently, in view of the above described problem, an object of the present invention is to provide an image processing apparatus in which the specific image including the regulation information and the specific image including the trace information are attached so that the specific images are different from each other.

### SUMMARY OF THE INVENTION

In order to achieve the above described object, the present invention is an image processing apparatus which adds a second specific image to image data having a first specific image, including a determination section for determining whether or not at least a part of the above described second specific image is the same as the above described first specific image, and an altering section for altering a part of the above described second specific image when it has been determined that at least a part of the above described second specific image is the same as the above described first specific image, wherein the altered second specific image is added to the above described image data.

The first specific image shows specific information such as regulation information like copy inhibition. In other words, since the regulation information is required to be recognized in each image processing apparatus, the first specific image is formed with a prescribed specific image.

The second specific image shows information for identifying each image processing apparatus, such as trace information. In other words, since information on the image processing apparatus is formed as an image in the second specific image, the second specific image is formed with a specific image different in each image processing apparatus.

Incidentally, the image processing apparatus may add both the first specific image and the second specific image to one image data. In this case, a part of the second specific image may be the same as the first specific image. Consequently, when the second specific image is added, the determination section verifies arrangement configuration of the first specific image to determine whether or not at least a part of the second specific image is the same as the first specific image.

The first specific image and the second specific image have specific patterns, respectively. In this case, the determination section determines whether or not a part of the specific pattern of the second specific image is the same as the specific pattern of the first specific image.

When the specific pattern of the second specific image is different from the specific pattern of the first specific image, the altering section does not alter the second specific image. The image processing apparatus adds the formed second specific image along with the first specific image to the image data.

When it has been determined that at least a part of the specific pattern of the second specific image is the same as the specific pattern of the first specific image, the altering section alters at least a part of the specific pattern of the second specific image.

As an altering method, for example, the altering section does not alter a part of the second specific image representing model information on the image processing apparatus, and alters a remaining part. In other words, the altering section does not alter a part of information required as the trace information included in the second specific image.

As another altering method, the altering section alters a part of the second specific image to be different from the first specific image. For example, the altering section alters a size of a component of the specific pattern of the second specific image to be added.

In order to prevent misdetection of the first specific image, the image processing apparatus is provided with a function such as executing a regulation processing when first specific images more than or equal to a predetermined threshold have been detected. In other words, when the first specific images more than a predetermined threshold have not been detected, the image processing apparatus does not execute the regulation processing. In this case, the altering section prevents misrecognition by altering the number of second specific images to be added to the image data. For example, the altering section alters the number of second specific images to be added to image data, to the number of second specific images to be added to the extent of not affecting the detection of the first specific image. It should be noted that this altering method is effective in the case where alteration of configuration of the second specific image is difficult.

The image processing apparatus has a storage section for storing multiple different second specific images, and when at least a part of the specific pattern of the second specific image is the same as the specific pattern of the first specific image, the altering section selects a second specific image with a specific pattern different from the specific pattern of the above described first specific image, from the above described storage section.

In addition to the case where the image processing apparatus simultaneously adds the first specific image and the second specific image generated by the image processing apparatus itself, there is the case where the first specific image is included in inputted image data. In this case, the image processing apparatus has to detect the first specific image from the image data.

Consequently, the image processing apparatus has a detection section for detecting the first specific image from an inputted image, and the determination section determines whether or not at least a part of the specific pattern of the second specific image is the same as the specific pattern of the above described detected first specific image. According to this configuration, the altering section alters the second specific image into a second specific image different from a read first specific image.

The present invention is an image processing apparatus which adds a second specific image to image data having a first specific image, including a determination section for determining whether or not at least a part of the above described second specific image is the same as the above described first specific image, and an altering section for stopping the addition of the above described second specific image when it has been determined that at least a part of the above described second specific image is the same as the above described first specific image. According to this configuration, when it has been determined that at least a part of the second specific image is the same as the first specific image, the second specific image is not added to the image data. Therefore, it is possible to prevent the image processing apparatus from misrecognizing the second specific image as the first specific image.

### BRIEF DESCRIPTION OF THE DRAWINGS

FIG. 1 is an overall diagram of an image processing apparatus according to this embodiment;

FIG. 2 is a block diagram of the image processing apparatus;

FIG. 3 is a block diagram of the image processing apparatus showing a flow of image data;

FIG. 4 is a diagram showing an example of a specific pattern of a first specific image;

FIG. 5 is a diagram showing an example in which the same specific pattern as the first specific image is included in a part of a specific pattern of a second specific image;

FIG. 6 is a diagram showing an example of the specific pattern of an altered second specific image; and

FIG. 7 is a flowchart diagram showing a flow when the second specific image is altered.

### DETAILED DESCRIPTION OF THE PREFERRED EMBODIMENTS

An image processing apparatus 1 of the present invention is a digital multifunction peripheral which executes processings of a copy mode, a print mode, a scanner mode, document filing, a facsimile mode and the like.

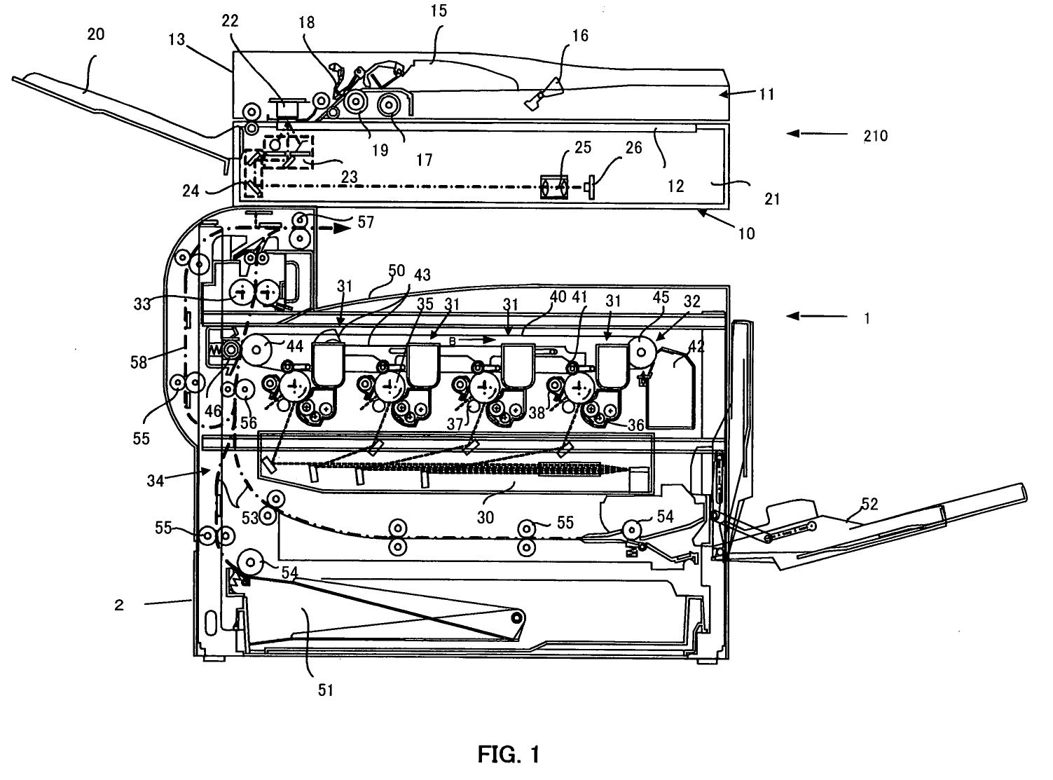

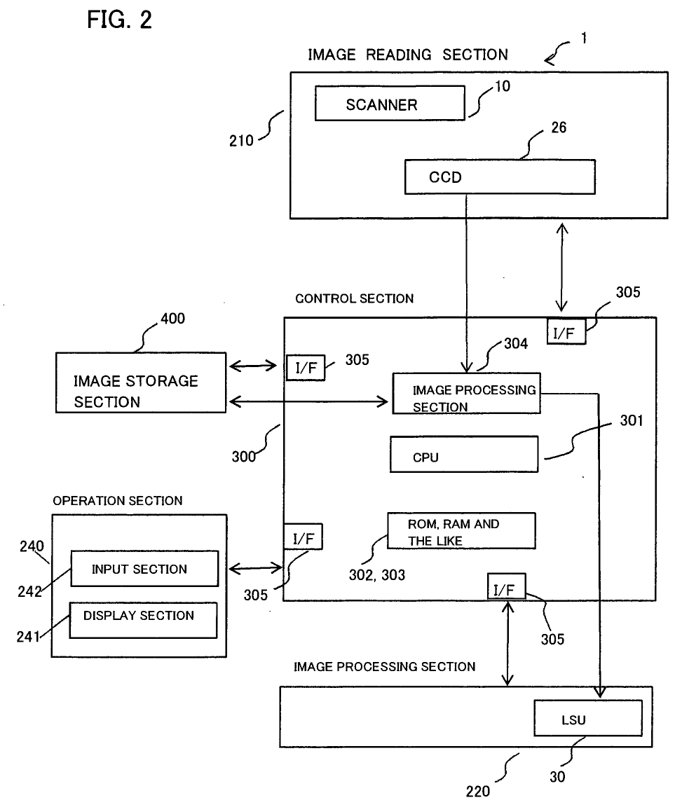

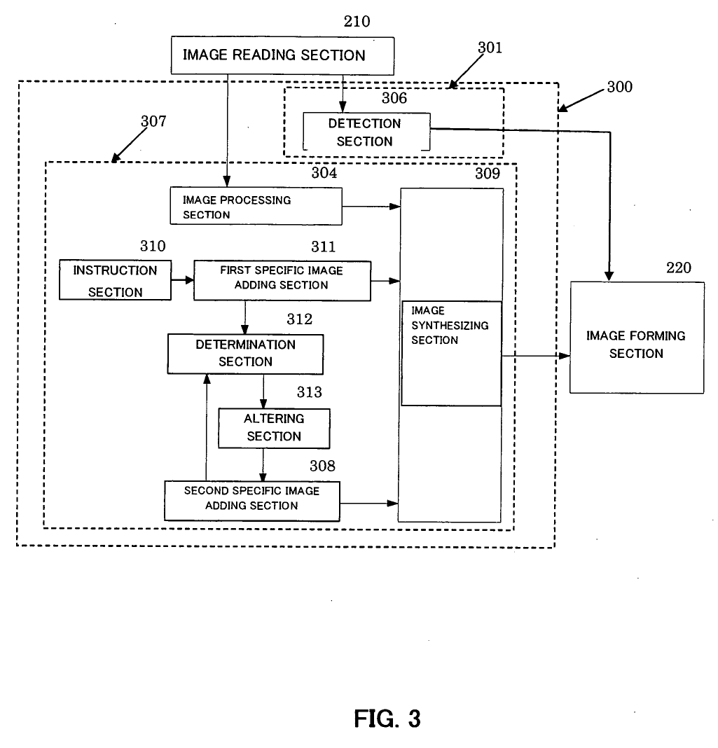

As shown in FIGS. 1 to 3, in a cabinet 2, this image processing apparatus 1 is provided with an image reading section 210 for reading a document and inputting image data, an image forming section 220 for processing and printing the image data, an image storage section 400 for storing the image data, an operation section 240 for input operations, and a control section 300 for controlling these apparatuses to execute processing of the image data depending on the mode.

The image reading section 210 reads an image of the document and processes the read image. The image reading section 210 is provided with a scanner section 10 for reading the image of a set document, and a CCD 26 for receiving a reflected light from the document and photoelectrically converting the image.

The image reading section 210 is placed on the upper side of the cabinet 2, and is provided with the scanner section 10 which is a reading section for reading the image of the document, and an automatic document conveying section 11. The automatic document conveying section 11 is provided on the upper side of the scanner section 10, and automatically conveys the document with respect to the scanner section 10.

On the upper surface of the cabinet 2, a document table 12 consisting of a platen glass is provided, and a document cover 13 for covering the document table 12 is provided. The automatic document conveying section 11 is mounted integrally with the document cover 13. The document cover 13 can be freely opened and closed, and when the document cover 13 is in a closed state, the document is conveyed by the automatic document conveying section 11. When the document cover 13 is in an opened state, the document can be placed on the document table 12.

Opening and closing of the document cover 13 are detected by a cover opening and closing detection section. The cover opening and closing detection section consists of a micro switch and a light sensor, and is turned on/off depending on the opening and closing of the document cover 13. Moreover, a document size detection sensor for detecting a size of the document placed on the document table 12 is provided.

When the document is set on a document setting tray 15 in the automatic document conveying section 11, a document detection sensor 16 detects that the document has been set. Then, at the operation section 240, copy conditions such as a size of a print sheet and a variable magnification are inputted. Subsequently, with the input operation on a start key, the reading of the image of the document is started.

In the automatic document conveying section 11, each document on the document setting tray 15 is drawn one by one by a pickup roller 17. The document is sent through between a control plate 18 and a conveyer roller 19 to the document table 12. The document is conveyed in a vertical scanning direction on the document table 12 and ejected to a document ejection tray 20. At the document ejection tray 20, a document ejection sensor is provided, and whether or not there is the document on the document ejection tray 20 is detected.

The scanner section 10 is provided with a first reading section 21 and a second reading section 22. A reading region is formed at one side of the document table 12. When the document is conveyed on the document table 12, the document passes through the reading region. A first scanning unit 23 in the first reading section 21 is located on the lower side of the reading region, and a front side (lower side surface) of the document is read.

When the document is conveyed to the document table 12 by the automatic document conveying section 11, the first scanning unit 23 is moved to a reading position and positioned there, and a second scanning unit 24 is also positioned at a predetermined position. The front side of the document is illuminated from the lower side of the document table 12 by an exposure lamp in the first scanning unit 23. Reflected light from the document is guided to an imaging lens 25 by respective reflecting mirrors in the first and second scanning units 23 and 24. The reflected light of the document is collected to the CCD 26 by the imaging lens 25. An image of the front side of the document is imaged on the CCD 26. Thereby, the image of the front side of the conveyed document is read.

Moreover, a back side (upper side surface) of the document is read by the second reading section 22. The second reading section 22 is placed on the upper side of the document table 12, and is provided with an LED which illuminates the back side of the document, an exposure lamp array having a fluorescent light or the like, a Selfoc lens array which collects the reflected light of the document for each pixel, a Contact Image Sensor which photoelectrically converts the reflected light from the document received through the Selfoc lens array and outputs an analog image signal, and the like. Thereby, an image of the back side of the conveyed document is read.

When the document has been placed on the document table 12, the image of the front side of the document is read by the first reading section 21. The first and second scanning units 23 and 24 move in the vertical scanning direction while mutually maintaining a predetermined velocity relationship. The document on the document table 12 is exposed by the first scanning unit 23, and the reflected light from the document is guided to the imaging lens 25 by the first and second scanning units 23 and 24. The image of the document is imaged on the CCD 26 by the imaging lens 25.

In this way, when the image of one side or the images of both sides of the document are read, image data of the one side or the both sides of the document is inputted to the control section 300. The control section 300 has an image processing section 304 for performing image processing with respect to the read image, and various kinds of image processing is applied to the image data by this image processing section 304. Specifically, when the image data is inputted from the image reading section 210, the image processing section 304 expands the inputted image data to generate an original image, and applies various kinds of image processing to the original image. This image data is outputted to the image forming section 220.

Based on synthesized image data, the image forming section 220 prints a color image or a monochrome image on a recording sheet. The image forming section 220 is provided with a laser scanning unit 30, four image stations 31, an intermediate transfer belt unit 32, a fixing apparatus 33 and a conveyer apparatus 34.

The respective image stations 31 form color images depending on respective colors of black, cyan, magenta and yellow, respectively. Each image station 31 is provided with a photoreceptor drum 35, a developing apparatus 36, a charging apparatus 37, a cleaning apparatus 38 and a neutralization apparatus (not shown).

The photoreceptor drum 35 is rotatably driven in one direction. The cleaning apparatus 38 cleans residual toner on a surface of the photoreceptor drum 35. The neutralization apparatus performs neutralization with respect to the surface of the photoreceptor drum 35. The charging apparatus 37 uniformly charges the surface of the photoreceptor drum 35.

The laser scanning unit 30 modulates laser light based on the image data inputted from the image reading section or the like, repetitively scans the surface of the photoreceptor drum 35 in a horizontal scanning direction with this laser light, and forms an electrostatic latent image on the surface of the photoreceptor drum 35. The developing apparatus 36 supplies toner to the surface of the photoreceptor drum 35, develops the electrostatic latent image, and forms a toner image on the surface of the photoreceptor drum 35.

The intermediate transfer belt unit 32 is provided with an intermediate transfer belt 40, an intermediate transfer roller 41, a transfer belt cleaning apparatus 42 and a tension mechanism 43. The intermediate transfer belt 40 is placed on the upper side of each photoreceptor drum 35, hung and wound around a driving roller 44 and a driven roller 45, and rotated in a direction of an arrow B.

The intermediate transfer roller 41 is placed to face the photoreceptor drum 35 with the intermediate transfer belt 40 therebetween, and applied with a transfer bias voltage. A voltage of reverse polarity with respect to the toner is applied by the intermediate transfer roller 41, and thereby the toner image on the surface of the photoreceptor drum 35 is transferred to the intermediate transfer belt 40. The toner image of each color is layered on the intermediate transfer belt 40, and a composite multicolor toner image is formed.

A transfer roller 46 is placed to be pressed against the intermediate transfer belt 40, and applied with the voltage of the reverse polarity with respect to the toner. The toner image on the intermediate transfer belt 40 is transferred on a sheet which has been conveyed between the transfer roller 46 and the intermediate transfer belt 40, by the transfer roller 46. Residual toner on the intermediate transfer belt 40 is removed by the transfer belt cleaning apparatus 42.

The toner image transferred on the sheet is heated and pressurized by the fixing apparatus 33 and fixed on the sheet, and the image is formed on the sheet. The sheet on which the image has been printed in this way is ejected to an ejection tray 50 provided on the upper side of the cabinet 2.

The conveyer apparatus 34 conveys the sheet from a sheet cassette 51 or a manual tray 52 along a conveying path 53. The conveying path 53 passes through between the intermediate transfer belt 40 and the transfer roller 46, and then through the fixing apparatus 33, and reaches the ejection tray 50.

The conveyer apparatus 34 is provided with a pickup roller 54, a conveyer roller 55, a resist roller 56 and an ejection roller 57. The sheet at the sheet cassette 51 or the manual tray 52 is sent to the conveying path 53 one by one, conveyed along the conveying path 53 and ejected to the ejection tray 50. While this sheet is conveyed, the image is printed on the sheet. Moreover, a switchback conveying path 58 is provided for double sided printing. The sheet on which the fixing has been performed is passed through the switchback conveying path 58 by the conveyer roller 55, and conveyed between the intermediate transfer belt 40 and the transfer roller 46. The sheet on which the double sided printing has been performed is passed through the fixing apparatus 33 and ejected to the ejection tray 50.

The operation section 240 is provided on the scanner section 10, and has an input section 242 and a display section 241. The input section 242 is provided with various operation keys. The display section 241 consists of a liquid crystal display, and is a touch panel. Touch keys are formed within an operation screen displayed on the display section 241, and these touch keys also function as the operation keys.

The image storage section 400 consists of a hard disk apparatus. The image storage section 400 stores the image data inputted from the image reading section 210. It should be noted that the inputted image data is stored in an image memory such as a DRAM temporarily, applied with the image processing or an encryption process, and subsequently transferred from the image memory to the image storage section 400. Moreover, when the image data is read from the image storage section 400, the image data is applied with the image processing or a decryption process, and stored in the image memory. Subsequently, the image data is outputted to the outside via the printing, data transmission or facsimile communication according to a process to be executed.

The control section 300 consists of a microcomputer having a CPU 301, a ROM 302 and a RAM 303, and the CPU 301 reads a control program stored in the ROM 302 out to the RAM 303 and executes the control program. According to the control program, the respective sections operate. When the image data is inputted, any mode among the print mode, the copy mode, the scanner mode and the facsimile mode is executed based on processing conditions included in information inputted from the input section 242 or header information of the image data inputted from an external apparatus.

When the control section 300 performs each mode, the control section 300 temporarily stores the inputted image data in the image storage section 400. Moreover, the control section 300 executes a filing mode for storing the inputted image data in the image storage section 400 and managing the image data. The stored image data is outputted again according to an instructed process.

The outputted image data is deleted from the image storage section 400, according to an instruction from the control section 300. In this deletion, the image data is disabled so that the image data cannot be restored, by overwriting the image data with random data. A security kit is mounted in the image processing apparatus in order to perform this disabling processing and further the encryption processing and the decryption processing. The security kit is operated according to the instruction from the control section 300, and thereby, unauthorized use of the image data can be prevented.

Here, in order to prevent confidential documents from being copied in an unauthorized manner or transmitted via facsimile, the control section 300 is provided with an adding section 307 for generating a second specific image B including a model number of the image processing apparatus which has performed the processing, or trace information for researching a user who has performed the processing, and a first specific image A including regulation information for performing regulation so that processes such as the unauthorized copy or the facsimile transmission of the confidential documents may not be performed, and synthesizing the first specific image A and the second specific image B into the image data.

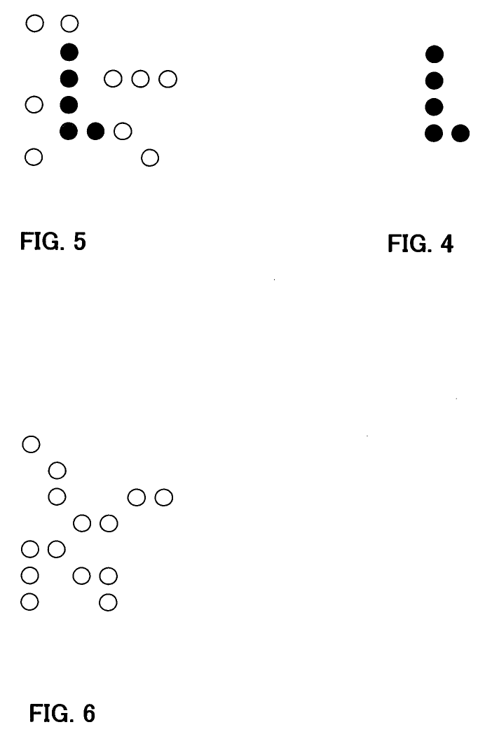

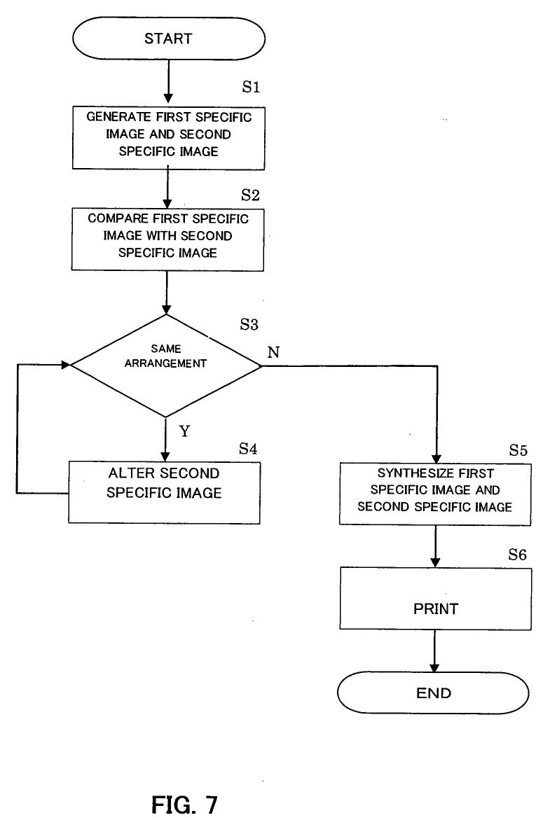

The first specific image A shows the information for regulating the processings with respect to the image data, such as copy inhibition, facsimile transmission inhibition and color print inhibition. Such information is referred to as “regulation information”. As shown in FIG. 4, the first specific image A is composed of multiple dots, and arrangement configuration of a specific pattern is specified so that all image processing apparatuses which have read the first specific image A can recognize the regulation information.

The second specific image B shows the information on the processing with respect to the image data, such as a model of the image processing apparatus, a serial number, a user who has instructed to perform the processing, and date and time of processing the image data. Such information is referred to as “trace information”. As shown in FIG. 5, the second specific image B is composed of multiple dots arranged based on a predetermined sequence, and the arrangement configuration of the specific pattern differs in each image processing apparatus so that the image processing apparatus which has recorded the image can be identified. In other words, in addition to this mode, as the second specific image B, a mode in which a character image, characters and the specific pattern are combined may be possible.

It is difficult for a person to visually recognize the first specific image A and the second specific image B. However, the first specific image A and the second specific image B can be read by the image reading section 210. A detection section 306 for detecting whether or not the first specific image A and the second specific image B are included in the image data inputted from the image reading section 210, and determining whether or not there are the first specific image A and the second specific image B, is provided in the control section 300. The image data is not limited to that inputted from the image reading section 210, and is inputted from the external apparatus, or a storage medium or a communication terminal, through a communication section.

Operations of the detection section 306 are controlled by the CPU 301, and the detection section 306 detects the first specific image A and the second specific image B by performing pattern matching between the inputted image data and image data corresponding to the first specific image A and the second specific image B. The image data corresponding to the first specific image A and the second specific image B has been previously registered and stored in a management table of the image storage section 400. Then, the detection section 306 detects the specific patterns of the first specific image A and the second specific image B, and determines which positions on the document the specific patterns of the first specific image A and the second specific image B have been recorded at. If the image data is in units of pages, the recorded specific patterns of the first specific image A and the second specific image B and their positions are detected for each page.

Operations of the adding section 307 are controlled by the CPU 301, and the adding section 307 has a second specific image adding section 308 for adding the second specific image B, a first specific image adding section 311 for adding the first specific image A, an instruction section 310 for controlling the first specific image adding section 311 to generate the first specific image A, a determination section 312 for determining whether or not a part of the second specific image B is the same as the first specific image, an altering section 313 for altering the second specific image when it has been determined that a part of the second specific image B is the same as the first specific image, and an image synthesizing section 309 for synthesizing the first specific image A and the second specific image B into the image data to generate print image data.

Operations of the second specific image adding section 308 are controlled by the CPU 301. In response to the instruction from the CPU 301, the second specific image adding section 308 generates the second specific image B based on a sequence which has been previously prescribed. Then, the second specific image adding section 308 outputs the second specific image B to the image synthesizing section 309.

Operations of the instruction section 310 are controlled by the CPU 301. Based on the instruction from the CPU 301 depending on inputted operation contents, the instruction section 310 controls the first specific image adding section 311 to generate the first specific image A. In response to an instruction from the instruction section 310, the first specific image adding section 311 generates the first specific image A based on the sequence which has been previously prescribed. Then, the first specific image adding section 311 outputs the first specific image A to the image synthesizing section 309.

It should be noted that the first specific image A and the second specific image B are not only generated based on the sequence, and multiple specific images may have been stored in the image storage section 400, and the first specific image adding section 311 and the second specific image adding section 308 may select appropriate specific images in response to the instruction from the CPU 301.

Operations of the determination section 312 are controlled by the CPU 301, and the determination section 312 determines whether or not a part of the second specific image B is the same as the first specific image, by performing the pattern matching between the first specific image A generated in the first specific image adding section 311 and the second specific image B generated in the second specific image adding section 308. Specifically, the determination section 312 verifies the arrangement configuration of the first specific image A generated in the first specific image adding section 311. Then, the determination section 312 determines whether or not there is the same specific pattern as the specific pattern of the verified first specific image A, in a part of the second specific image B. For example, if the first specific image A is a pattern shown by black dots as shown in FIG. 4, a part of the black dots which is a part of the second specific image B matches the specific pattern of the first specific image A, as shown in FIG. 5. At this time, the determination section 312 determines that a part of the second specific image B is the same as the first specific image A.

It should be noted that the determination section 312 also determines that a part of the second specific image B is the same as the first specific image A if the second specific image has matched the first specific image. Moreover, a part of the second specific image is not required to totally match the first specific image, and if a degree of similarity is more than or equal to a specified value, the determination section 312 determines that a part of the second specific image B is the same as the first specific image A. This specified value can be set. For example, the specified value is set by an administrator of the image processing apparatus or a manufacturer.

The altering section 313 is controlled by the CPU 301, and when it has been determined that a part of the second specific image B is the same as the first specific image A, the altering section 313 alters the specific pattern of the second specific image B to be different from the first specific image A, and outputs the altered second specific image B to the second specific image adding section 308.

As an altering method, the altering section 313 alters the specific pattern of the second specific image B. In other words, as shown in FIGS. 5 and 6, the altering section 313 alters the second specific image B into a different specific pattern. For example, the altering section 313 does not alter a part of the second specific image B, and alters a remaining part. In other words, the altering section 313 does not alter important trace information, for example, a part of the second specific image B showing the information such as the serial number of the image processing apparatus or the information on the user who has instructed to perform the processing, and alters a part showing information which is not particularly required as the trace information.

Alternatively, a size of the dot or a pitch of the dot of the second specific image B is altered. For example, the altering section 313 confirms a size of the dot of the first specific image A to be added, and alters the second specific image B into a second specific image B composed of dots larger or smaller than that size. Alternatively, the altering section 313 confirms a pitch of the dot of the first specific image A to be added, and alters the second specific image B into a second specific image B composed of dots larger or smaller than that pitch.

As another altering method, the altering section 313 stops the addition of the second specific image B with respect to the image data. In other words, the altering section 313 outputs the second specific image B to the second specific image adding section 308 so that the second specific image B is not added. The second specific image adding section 308 does not add the generated second specific image B.

As another altering method, when multiple second specific images B with different specific patterns have been stored in the image storage section 400, and it has been determined that a part of the second specific image B is the same as the first specific image A, the altering section 313 selects the second specific image B which does not become the same as the first specific image A, from the image storage section 400, and outputs the second specific image B to the second specific image adding section 308. The second specific image adding section 308 outputs the inputted second specific image B to the image synthesizing section 309.

As another altering method, the altering section 313 alters the number of second specific images B to be added to the image data. For example, when it has been determined that a part of the second specific image B is the same as the first specific image A, the altering section 313 reduces the number of second specific images B to be added to the image data. Thereby, when the printed document is read, misdetection of the copy inhibition information can be prevented.

The altering section 313 uses any set method among the above described altering methods to alter the second specific image. It should be note that the above described altering methods may be simultaneously used. Alternatively, any two or three altering methods may be used together. These can be set.

Moreover, if the second specific image B has been altered, the altering section 313 stores the altered second specific image B in the image storage section 400. Since the altered second specific image has been stored, it becomes possible to trace a source of a recorded material to identify a person who has performed the unauthorized use.

The image synthesizing section 309 synthesizes the first specific image A and the second specific image B into the inputted image data, and based on the instruction from the CPU 301, generates the print image data and outputs the print image data to the image forming section 220.

Next, an operation of determining whether or not a part of the second specific image is the same as the first specific image A, and altering the second specific image B when it has been determined that a part of the second specific image is the same as the first specific image A will be described. It should be noted that, for convenience of explanation, the second specific image B is altered as shown in FIGS. 5 and 6. In other words, the altering method in the altering section 313 alters the specific pattern of the second specific image. Moreover, the executed mode is the copy mode.

First, the user places the document on the document table 12, and operates the operation keys to select a desired processing. When the start key is operated, the CPU 301 causes the image reading section 210 to start a reading operation based on the inputted operation contents.

The image reading section 210 reads the image of the document placed on the document table 12. The image reading section 210 outputs the read image to the image processing section 304 and the detection section 306.

The detection section 306 detects whether or not there is the first specific image A in the read image. If the first specific image A has been detected, the detection section 306 confirms the regulation information included in the first specific image A. If the first specific image includes the regulation information for restricting processings to be executed, such as the copy inhibition, reduction of image quality, inhibition of the data transmission or the facsimile transmission, and filing inhibition, the detection section 306 outputs a result thereof to the image forming section 220. The image forming section 220 stops a processing being executed, based on the received regulation information.

Furthermore, the detection section 306 instructs the display section 241 to display a display screen showing that a printing process has been stopped, and the display section 241 displays the display screen of the stop of the process. Then, the image processing apparatus is put into a waiting state until next operation input is performed.

If the first specific image A has not been detected, the detection section 306 determines that there is no regulation information. Then, the detection section 306 outputs a result thereof to the image forming section 220.

The image data outputted to the image processing section 304 is processed concurrently with a task of discriminating whether or not there is the first specific image by the detection section 306. Specifically, based on the processing conditions included in the header information of the image data, the CPU 301 controls the image processing section 304, the second specific image adding section 308, the instruction section 310, the determination section 312, the altering section 313 and the image synthesizing section 309.

When the image data is inputted, the image processing section 304 expands the image data to generate the original image, applies the various kinds of image processing with respect to the original image, and outputs the original image to the image synthesizing section 309. Based on the instruction from the CPU 301, the instruction section 310 controls the first specific image adding section 311 to generate the first specific image A. In response to the instruction from the instruction section 310, the first specific image adding section 311 generates the first specific image A, and outputs the first specific image A to the determination section 312 and the image synthesizing section 309 (S1). The second specific image adding section 308 generates and outputs a device identifying pattern to the determination section 312 (S2).

The determination section 312 verifies the arrangement configuration of the inputted first specific image A. Then, the determination section 312 determines whether or not a part of the second specific image B is the same as the specific pattern of the verified first specific image A (S3).

If it has been determined that there is no specific pattern of the first specific image A in the second specific image B, the determination section 312 outputs a result of the determination along with the second specific image B to the altering section 313.

Based on the input from the determination section 312, the altering section 313 outputs the inputted second specific image B to the second specific image adding section 308 without alteration. Then, the second specific image adding section 308 outputs the second specific image B to the image synthesizing section 309.

The image synthesizing section 309 synthesizes the first specific image A and the second specific image B into the inputted image data, and based on the instruction from the CPU 301, generates and outputs a print image data to the image forming section 220 (S5). The image forming section 220 prints the synthesized image data on the recording sheet, and outputs it (S6).

If it has been determined that there is the specific pattern of the first specific image A in the second specific image B, the determination section 312 outputs a result of the determination along with the second specific image B to the altering section 313.

Based on the input from the determination section 312, the altering section 313 alters the inputted second specific image B. Then, it is determined whether or not a part of the altered second specific image B is the same as the first specific image A. If it has been determined that there is no specific pattern of the first specific image A in the second specific image B, the determination section 312 outputs a result of the determination along with the second specific image B to the altering section 313. If it has been determined that there is the specific pattern of the first specific image A in the second specific image B, the determination section 312 outputs a result of the determination along with the second specific image B to the altering section 313, and the second specific image is altered and confirmed again. This processing is performed until it is determined that there is no specific pattern of the first specific image A in the second specific image B.

The altered second specific image B is outputted to the second specific image adding section 308. Then, the second specific image adding section 308 outputs the second specific image B to the image synthesizing section 309.

The image synthesizing section 309 synthesizes the first specific image A and the second specific image B into the inputted image data, and based on the instruction from the CPU 301, generates and outputs a print image data to the image forming section 220 (S5). The image forming section 220 prints the synthesized image data on the recording sheet, and outputs it (S6).

Thereby, the second specific image B is necessarily different from the first specific image A. Therefore, when the outputted document is copied, the processing can be regulated. Moreover, the image processing apparatus which has outputted the document can be identified.

It should be noted that when the regulation information included in the first specific image A is detected, an inhibition mode for stopping the process being executed is executed. However, when a document such as a book has to be copied, an authenticated user can cancel this inhibition mode. In other words, the authenticated user sets the inhibition mode to be disabled in mode setting.

It should be noted that the present invention is not limited to the above described embodiment, and of course, it is possible to add many modifications and alterations to the above described embodiment within the range of the present invention. For example, when the document attached with the first specific image including the regulation information is copied, if the authenticated user has canceled a regulation mode such as the copy inhibition, the color print inhibition, and reducing a resolution and permitting the print, and copied the document, the first specific image added to the document is also recorded in the image. In this case, the determination section also determines whether or not the read first specific image is included in the second specific image. When it has been determined that the second specific image is the same as the read first specific image, the altering section alters the second specific image into a second specific image different from the read first specific image, and adds the second specific image to the image data. Thereby, since the second specific image is different from the first specific image, even if both the first specific image and the second specific image have been added to one image, misrecognition can be prevented.

What is claimed is:

1. An image processing apparatus which adds a second specific image to image data having a first specific image, comprising:
a determination section for determining whether or not at least a part of said second specific image is the same as said first specific image; and
an altering section for altering a part of said second specific image when it has been determined that at least a part of said second specific image is the same as said first specific image,
wherein the altered second specific image is added to said image data.

2. The image processing apparatus according to claim 1, wherein the first specific image and the second specific image have specific patterns, and
the determination section determines whether or not at least a part of the specific pattern of the second specific image is the same as the specific pattern included in the first specific image.

3. The image processing apparatus according to claim 2, wherein when at least a part of the specific pattern of the second specific image is the same as the specific pattern of the first specific image, the altering section alters at least a part of the specific pattern of the second specific image.

4. The image processing apparatus according to claim 3, wherein the altering section alters a size of a component of the specific pattern of the second specific image.

5. The image processing apparatus according to claim 2, wherein when at least a part of the specific pattern of the second specific image is the same as the specific pattern of the first specific image, the altering section alters the number of second specific images to be added to image data to be outputted.

6. The image processing apparatus according to claim 2, further comprising:
a storage section for storing multiple different second specific images,
wherein when at least a part of the specific pattern of the second specific image is the same as the specific pattern of the first specific image, the altering section selects a second specific image with a specific pattern different from the specific pattern of said first specific image, from said storage section.

7. The image processing apparatus according to claim 2, further comprising:
a detection section for detecting the first specific image from inputted image data,
wherein the determination section determines whether or not at least a part of the specific pattern of the second specific image is the same as the specific pattern of said detected first specific image.

8. The image processing apparatus according to claim 1, wherein the first specific image includes information for restricting processings, and the second specific image includes information for identifying the image processing apparatus.

9. The image processing apparatus according to claim 8, wherein the altering section does not alter a part of the second specific image representing model information on the image processing apparatus, and alters a remaining part.

10. An image processing apparatus which adds a second specific image to image data having a first specific image, comprising:
a determination section for determining whether or not at least a part of said second specific image is the same as said first specific image; and
an altering section for stopping the addition of said second specific image when it has been determined that at least a part of said second specific image is the same as said first specific image.

11. The image processing apparatus according to claim 10, wherein the first specific image includes information for restricting processings, and the second specific image includes information for identifying the image processing apparatus.
